(19) United States
(12) Patent Application Publication
(10) Pub. No.: US 2001/0053832 A1
(43) Pub. Date: Dec. 20, 2001

(54) Olefin polymerization catalyst and process for producing olefin polymer

(76) Inventor: Tsuyoshi Watanabe, Ichihara-shi (JP)

Correspondence Address: BIRCH STEWART KOLASCH & BIRCH, PO BOX 747, FALLS CHURCH, VA, 22040-0747, US

(21) Appl. No.: 09/800,930

(22) Filed: Mar. 8, 2001

(30) Foreign Application Priority Data
Mar. 10, 2000 (JP) 2000-066904

(51) Int. Cl. C08F 4/44

(52) U.S. Cl. 526/127; 526/153; 526/160; 526/943; 526/161; 502/155; 502/152; 502/153

(57) ABSTRACT

An olefin polymerization catalyst prepared by a process comprises contacting (A) a transition metal compound in which the number of a transition metal is the same as that of group having a cyclopentadiene type anion skeleton, in its molecule, (C) a modified aluminumoxy compound obtained by reacting an aluminumoxy compound with a boron compound represented by the general formula BQ¹Q²Q³, wherein Q¹, Q² and Q³ are respectively a halogen atom, a hydrocarbon group, a halogenated hydrocarbon group, a substituted silyl group, an alkoxy group or a di-substituted amino group and optionally (B) a specified organoaluminum compound, and a process for producing an olefin polymer using the catalyst.

### BACKGROUND OF THE INVENTION

1. Field of the Invention

The present invention relates to an olefin polymerization catalyst prepared by using a modified aluminumoxy compound as one component, and a process for producing an olefin polymer with said catalyst.

2. Description of Related Arts

Many processes for producing an olefin polymer using a metallocene complex have been already reported. For example, a process for producing an olefin polymer, using a metallocene complex and an aluminoxane is reported in JP58-19306A. However, this process using bis(η⁵-cyclopentadienyl)zirconium dichloride and methylaluminoxane provided olefin polymers of low molecular weight.

Though many proposals relating to modification of an aluminum oxy compound have been reported in order to solve these problems, there have been few proposals relating to a method for increasing the molecular weight of olefin polymers.

For example, JP-A-02-172991 discloses a benzene-insoluble aluminumoxy compound prepared by reacting an aluminoxane with water. Further, JP-A-07-70145 discloses an aluminumoxy compound obtained by reacting an aluminoxane with a catecol borane. The increase of the molecular weight of the olefin polymer according to these methods has not been completed.

Though an olefin polymerization process using zirconocene and an aluminum oxy compound having an electron withdrawing group such as a pentafluorophenoxy group or the like is disclosed in JP-A-06-329714, the molecular weight of the olefin polymers obtained is not necessarily sufficient. Therefore, the more increase of the molecular weight has been required.

Though Choong Hoon Lee et al. in Journal of Molecular Catalysis A: Chemical 132(1998)231-239, reported with respect to olefin polymerization using a reaction product of methylaluminoxane and trispentafluorephenylborane, and bis (cyclopentadienyl) zirconium dichloride, the molecular weight of the olefin polymer was not mentioned.

As a method for increasing a molecular weight of a olefin polymer, thought JP-A-64-045406 discloses an olefin polymerization method which uses bis(cyclopentadienyl)zirconium dichloride, methylaluminoxane and tetraethoxysilane, the molecular weight of thus obtained olefin polymer was insufficient from the industrial view point. Particularly, when copolymerization of ethylene with 1-hexene is carried out at high temperature, the molecular weight of thus obtained copolymer was very low.

Further, JP-A-09-087313discloses a process for producing a copolymer of ethylene with 1-hexene using dimethylsilylene(tetramethylcyclopentadienyl) (3-tert-butyl-5-methyl-2-phenoxy)titanium dichloride, triisobutylaluminum and N,N-dimethylaniliniumtetrakis (pentafluorophenyl)borate. Though a copolymer of comparatively high molecular weight is obtained with a high activity by using them, further increase of the molecular weight has been desired .

### SUMMARY OF THE INVENTION

An object of the present invention is to provide an olefin polymerization catalyst giving an olefin polymer of higher molecular weight and a process for producing an olefin polymer having a high molecular weight using said catalyst.

The present inventors have extensively studied concerning modification of an aluminumoxy compound for long time, and as results, found a specific olefin polymerization catalyst prepared by using a modified aluminumoxy compound obtained by pre-reacting an aluminumoxy compound with a specific boron compound, and the like; and a process for producing an olefin polymer by polymerizing an olefin with said olefin polymerization catalyst.

That is, the present invention relates to an olefin polymerization catalyst prepared by contacting (A) with (B) described below, or (A), (B) and (C) described below, and further to a process for producing an olefin polymer which comprises polymerizing an olefin with said catalyst:

(A) a transition metal compound in which the number of a transition metal is the same as that of group having a cyclopentadiene type anion skeleton, in its molecule.

(B) at least one aluminum compound selected from the following (B1) to (B3);

(B1) an organoaluminum compound represented by the general formula E¹ₐAlZ₃₋ₐ,

(B2) acyclic aluminoxane having a structure represented by the general formula {—Al(E²)—O—}_{b}, and

(B3) a linear aluminoxane having a structure represented by the general formula E³{—Al(E³)—O—}_{c}AlE³₂

(wherein E¹, E² and E³ respectively represents a hydrocarbon group, all of E¹, E² and E³ may be the same or different, Z represents a hydrogen atom or a halogen atom, and all of Z may be the same or different, a represents a numeral satisfying 0<a≦3, b represents an integer of not less than 2, and c represents an integer of not less than 1); and

(C)a modified aluminumoxy compound obtained by reacting (c1) an aluminumoxy compound with a boron compound represented by the general formula BQ¹Q²Q³

(wherein B is a boron atom in the trivalent valence state; and Q¹, Q² and Q³are respectively a halogen atom, a hydrocarbon group, a halogenated hydrocarbon group, a substituted silyl group, an alkoxy group or a di-substituted amino group which may be the same or different).

### BRIEF DESCRIPTION OF THE DRAWING

FIG. 1 shows a flowchart for assisting the understanding of the present invention. The flowchart is atypical example of the mode of operation of the present invention, but the present invention is not limited thereto.

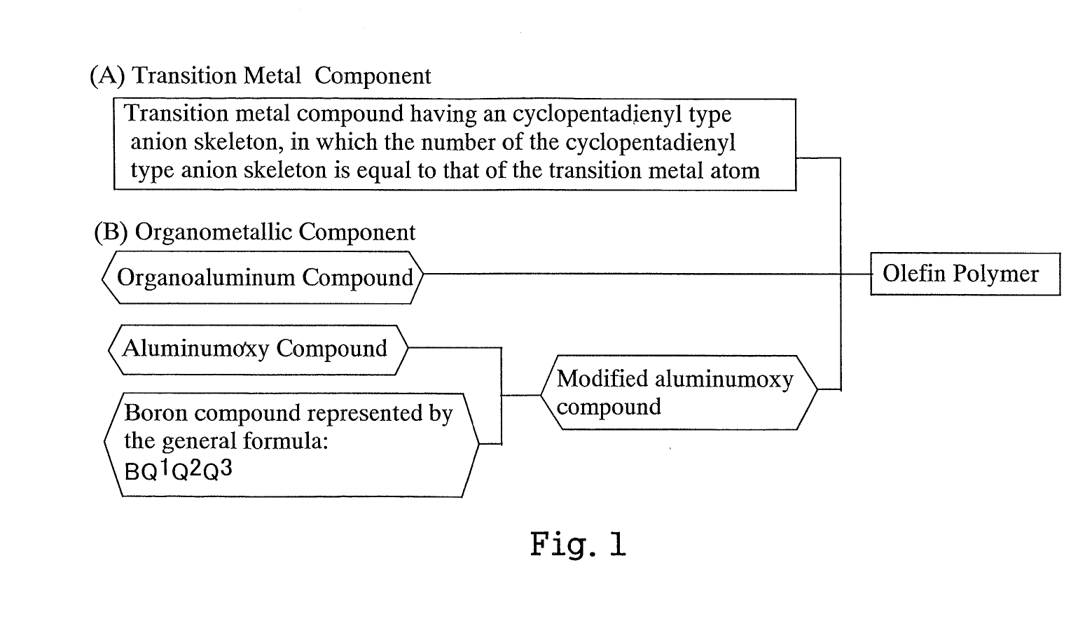

### DETAILED DESCRIPTION OF THE INVENTION

The present invention is further illustrated in detail below.

(A)Transition Metal Compound

The transition metal compound is a transition metal compound in which the number of a transition metal of the Group IV of the Periodic Table of the Elements is the same as that of a group having a cyclopentadiene type anion skeleton, in its molecule, and for example, a transition metal compound having one transition metal of the Group IV and one group having a cyclopentadiene type anion skeleton, and a μ-oxo type dimmer thereof.

Herein, the transition metal atom of the Group IV represents a transition metal atom of the Group IV of the Periodic Table of the Elements (Revised edition of IUPAC Inorganic Chemistry Nomenclature 1989), and examples thereof include a titanium atom, a zirconium atom, a hafnium atom and the like. A titanium atom or a zirconium atom is preferable.

The transition metal compound used in the present invention is preferably a transition metal compound represented by the general formula (I) or (II):

CpMX¹₃ (I)

(CpMX¹ₘ)₂X²₃₋ₘ (II)

(wherein M represents a transition metal atom of the Group IV of the Periodic Table of the Elements; Cp represents a group having a cyclopentadiene type anion skeleton; each of X¹ represents a hydrogen atom, a halogen atom, an alkyl group, an aralkyl group, an aryl group, a substituted silyl group, an alkoxy group, an aralkyloxy group, an aryloxy group, a di-substituted amino group, an alkylthio group, an aralkylthio group, an arylthio group, an alkylseleno group, an aralkylseleno group or arylseleno group; X² represents an atom of Group XVI of the Periodic Table of the Elements; m is 1 or 2; and a plurarity of respective Cp, M, X¹ and X² may be the same or different and Cp and X¹ may be bonded each other directly through a bridging group.)

M is the same transition metal atom of the Group IV of the Periodic Table of the Elements as described above.

Further, examples of the group having a cyclopentadiene type anion skeleton represented as the substituent group, Cp, include an η⁵-(substituted)cyclopentadienyl group, an η⁵ (substituted)indenyl group, an η⁵-(substituted) fluorenyl group and the like. Specific examples include an η⁵-cyclopentadienyl group, an η⁵-methylcyclopentadienyl group, an η⁵-dimethylcyclopentadienyl group, an η⁵-trimethylcyclopentadienyl group, an η⁵-tetramethylcyclopentadienyl group, an η⁵-pentamethylcyclopentadienyl group, an η⁵-ethylcyclopentadienyl group, an η⁵-n-propylcyclopentadienyl group, an η⁵-isopropylcyclopentadienyl group, an η⁵-n-butylcyclopentadienyl group, an η⁵-sec-butylcyclopentadienyl group, an η⁵-tert-butylcyclopentadienyl group, an η⁵-phenylcyclopentadienyl group, an η⁵-trimethylsilylcyclopentadienyl group, an η⁵-tert-butyldimethylsilylcyclopentadienyl group, an η⁵-indenyl group, an η⁵-methylindenyl group, an η⁵-dimethylindenyl group, an η⁵-n-propylindenyl group, an η⁵-isopropylindenyl group, an η⁵-n-butylindenyl group, an η⁵-tert-butylindenyl group, an η⁵-phenylindenyl group, an η⁵-methylphenylindenyl group, an η⁵-naphthylindenyl group, an η⁵-trimethylsilylindenyl group, an η⁵-tetrahydroindenyl group, an η⁵-fluorenyl group, an η⁵-methylfluorenyl group, an η⁵-dimethylfluorenyl group, an η⁵-tert-butylfluorenyl group, an η⁵-di-tert-butylfluorenyl group, an η⁵-phenylfluorenyl group, an η⁵-diphenylfluorenyl group, an η⁵-trimethylsilylfluorenyl group, an η⁵-bis-trimethylsilylfluorenyl group and the like. An η⁵-cyclopentadienyl group, an η⁵-methylcyclopentadienyl group, an η⁵-n-butylcyclopentadienyl group, an η⁵-tert-butylcyclopentadienyl group, an η⁵-tetramethylcyclopentadienyl group, an η⁵-indenyl group, an η⁵-tetrahydroindenyl group or an η⁵-fluorenyl group is preferable.

As the halogen atom in the substituent, X¹, a fluorine atom, a chlorine atom, a bromine atom and an iodine atom are illustrated. A chlorine atom or a bromine atom is preferable and a chlorine atom is more preferable.

As the alkyl group in the substituent, X¹, an alkyl group having 1 to 20 carbon atoms is preferred, and examples include a methyl group, an ethyl group, a n-propyl group, an isopropyl group, a n-butyl group, a sec-butyl group, a tert-butyl group, an isobutyl group, a n-pentyl group, a neopentyl group, a sec-amyl group, a n-hexyl group, a n-octyl group, a n-decyl group, a n-dodecyl group, a n-pentadecyl group, a n-eicosyl group and the like, and a methyl group, an ethyl group, an isopropyl group, a tert-butyl group or an isobutyl group or a sec-amyl group is more preferable.

All of these alkyl groups may be substituted with a halogen atom such as a fluorine atom, a chlorine atom, a bromine atom or an iodine atom. Examples of the alkyl group having 1 to 10 carbon atoms which is substituted with the halogen atom, include a fluoromethyl group, a trifluoromethyl group, a chloromethyl group, a trichloromethyl group, a fluoroethyl group, a pentafluoroethyl group, a perfluoropropyl group, a perfluorobutyl group, a perfluorohexyl group, a perfluorooctyl group, a perchloropropyl group, a perchlorobutyl group, a perbromopropyl group and the like.

Further, all of these alkyl groups may be partially substituted with an alkoxy group such as a methoxy group, an ethoxy group or the like, an aryloxy group such as a phenoxy group or the like or an aralkyloxy group such as a benzyloxy group or the like, etc.

As the aralkyl group in the substituent, X¹, an aralkyl group having 7 to 20 carbon atoms is preferable, and examples thereof include a benzyl group, a (2-methylphenyl)methyl group, a (3-methylphenyl)methyl group, a (4-methylphenyl)methyl group, a (2,3-dimethylphenyl)methyl group, a (2,4-dimethylphenyl)methyl group, a (2,5-dimethylphenyl)methyl group, a (2,6-dimethylphenyl)methyl group, a (3,4-dimethylphenyl)methyl group, a (3,5-dimethylphenyl)methyl group, a (2,3,4-timethylphenyl)methyl group, a (2,3,5-timethylphenyl)methyl group, a (2,3,6-timethylphenyl)methyl group, a (3,4,5-timethylphenyl)methyl group, a (2,4,6-timethylphenyl)methyl group, a (2,3,4,5-tetramethylphenyl)methyl group, a (2,3,4,6-tetramethylphenyl)methyl group, a (2,3,5,6-tetramethylphenyl)methyl group, a (pentamethylphenyl) methyl group, an (ethylphenyl)methyl group, a (n-propylphenyl)methyl group, an (isopropylphenyl)methyl group, a (n-butylphenyl)methyl group, a (sec-butylphenyl)methyl group, a (tert-butylphenyl)methyl group, a (n-pentylphenyl)methyl group, a (neopentylphenyl)methyl group, a (n-hexylphenyl)methyl group, a (n-octylphenyl)methyl group, a (n-decylphenyl)methyl group, a (n-dodecylphenyl)methyl group, a naphthylmethyl group, an anthracenylmethyl group and the like, and a benzyl group is more preferable.

All of these aralkyl groups may be partially substituted with a halogen atom such as a fluorine atom, a chlorine atom, a bromine atom or an iodine atom, an alkoxy group such as a methoxy group, an ethoxy group or the like, an aryloxy group such as a phenoxy group or the like or an aralkyloxy group such as a benzyloxy group or the like, etc.

As the aryl group in the substituent, X¹, an aryl group having 6 to 20 carbon atoms is preferable, and examples thereof include a phenyl group, a 2-tolyl group, a 3-tolyl group, a 4-tolyl group, a 2,3-xylyl group, a 2,4-xylyl group, a 2,5-xylyl group, a 2,6-xylyl group, a 3,4-xylyl group, a 3,5-xylyl group, a 2,3,4-trimethylphenyl group, a 2,3,5-trimethylphenyl group, a 2,3,6-trimethylphenyl group, a 2,4,6-trimethylphenyl group, a 3,4,5-trimethylphenyl group, a 2,3,4,5-tetramethylphenyl group, a 2,3,4,6-tetramethylphenyl group, a 2,3,5,6-tetramethylphenyl group, a pentamethylphenyl group, an ethylphenyl group, a n-propylphenyl group, an isopropylphenyl group, a n-butylphenyl group, a sec-butylphenyl group, a tert-butylphenyl group, a n-pentylphenyl group, a neopentylphenyl group, a n-hexylphenyl group, a n-octylphenyl group, a n-decylphenyl group, a n-dodecylphenyl group, a n-tetradecylphenyl group, a naphthyl group, an anthracenyl group and the like, and a phenyl group is more preferable.

All of these aryl groups may be partially substituted with a halogen atom such as a fluorine atom, a chlorine atom, a bromine atom or an iodine atom, an alkoxy group such as a methoxy group, an ethoxy group or the like, an aryloxy group such as a phenoxy group or the like or an aralkyloxy group such as a benzyloxy group or the like, etc.

The substituted silyl group in the substituent, X¹, is a silyl group substituted with a hydrocarbon group, and examples of the hydrocarbon group include alkyl groups having 1 to 10 carbon atoms such as a methyl group, an ethyl group, a n-propyl group, an isopropyl group, a n-butyl group, a sec-butyl group, a tert-butyl group, an isobutyl group, a n-pentyl group, a n-hexyl group, a cyclohexyl group and the like, and aryl groups having up to 10 carbon atoms such as a phenyl group and the like, etc. Examples of such substituted silyl group having 1 to 20 carbon atoms include mono-substituted silyl groups having 1 to 20 carbon atoms such as a methylsilyl group, an ethylsilyl group, a phenylsilyl group and the like; di-substituted silyl groups having 2 to 20 carbon atoms such as a dimethylsilyl group, a diethylsilyl group, a diphenylsilyl group and the like; and tri-substituted silyl groups having 3 to 20 carbon atoms such as a trimethylsilyl group, a triethylsilyl group, a tri-n-propylsilyl group, a triisopropylsilyl group, a tri-n-butylsilyl group, a tri-sec-butylsilyl group, a tri-tert-butylsilyl group, a tri-isobutylsilyl group, a tert-butyl-dimethylsilyl group, a tri-n-pentylsilyl group, a tri-n-hexylsilyl group, a tricyclohexylsilyl group, a triphenylsilyl group and the like, and a trimethylsilyl group, a tert-butyldimethylsilyl group or a triphenylsilyl group is preferable.

All of the hydrocarbon groups of these substituted silyl groups may be partially substituted with a halogen atom such as a fluorine atom, a chlorine atom, a bromine atom or an iodine atom, an alkoxy group such as a methoxy group, an ethoxy group or the like, an aryloxy group such as a phenoxy group or the like or an aralkyloxy group such as a benzyloxy group or the like, etc.

As the alkoxy group in the substituent, X¹,an alkoxy group having 1 to 20 carbon atoms is preferable, and examples thereof include a methoxy group, an ethoxy group, a n-propoxy group, an isopropoxy group, a n-butoxy group, a sec-butoxy group, a tert-butoxy group, a n-pentoxy group, a neopentoxy group, an-hexoxygroup, an-octoxygroup, an-dodecoxygroup, a n-pentadecoxy group, a n-eicosoxy group and the like, and a methoxy group, an ethoxy group, an isopropoxy group or a tert-butoxy group is preferable.

All of these alkoxy groups may be partially substituted with a halogen atom such as a fluorine atom, a chlorine atom, a bromine atom or an iodine atom, an alkoxy group such as a methoxy group, an ethoxy group or the like, an aryloxy group such as a phenoxy group or the like or an aralkyloxy group such as a benzyloxy group or the like, etc.

As the aralkyloxy group in the substituent, X¹, an aralkyloxy group having 7 to 20 carbon atoms is preferable, and examples thereof include a benzyloxy group, a (2-methylphenyl)methoxy group, a (3-methylphenyl)methoxy group, a (4-methylphenyl)methoxy group, a (2,3-dimethylphenyl)methoxy group, a (2,4-dimethylphenyl)methoxy group, a (2,5-dimethylphenyl)methoxy group, a (2,6-dimethylphenyl)methoxy group, a (3,4-dimethylphenyl)methoxy group, a (3,5-dimethylphenyl)methoxy group, a (2,3,4-trimethylphenyl)methoxy group, a (2,3,5-trimethylphenyl)methoxy group, a (2,3,6-trimethylphenyl)methoxy group, a (2,4,5-trimethylphenyl)methoxy group, a (2,4,6-trimethylphenyl)methoxy group, a (3,4,5-trimethylphenyl)methoxy group, a (2,3,4,5-tetramethylphenyl)methoxy group, a (2,3,4,6-tetramethylphenyl)methoxy group, a (2,3,5,6-tetramethylphenyl)methoxy group, a (pentamethylphenyl)methoxy group, an (ethylphenyl)methoxy group, a (n-propylphenyl)methoxy group, an (isopropylphenyl)methoxy group, (n-butylphenyl)methoxy group, a (sec-butylphenyl)methoxy group, a (tert-butylphenyl)methoxy group, a (n-hexylphenyl)methoxy group, a (n-octylphenyl)methoxy group, a (n-decylphenyl)methoxy group, a naphthylmethoxy group, an anthracenylmethoxy group and the like, and a benzyloxy group is more preferable.

All of these aralkyloxy groups may be partially substituted with a halogen atom such as a fluorine atom, a chlorine atom, a bromine atom or an iodine atom, an alkoxy group such as a methoxy group, an ethoxy group or the like, an aryloxy group such as a phenoxy group or the like or an aralkyloxy group such as a benzyloxy group or the like, etc.

As the aryloxy group in the substituent X¹, an aryloxy group having 6 to 20 carbon atoms is preferable, and examples thereof include a phenoxy group, a 2-methylphenoxy group, a 3-methylphenoxy group, a 4-methylphenoxy group, a 2,3-dimethylphenoxy group, a 2,4-dimethylphenoxy group, a 2,5-dimethylphenoxy group, a 2,6-dimethylphenoxy group, a 3,4-dimethylphenoxy group, a 3,5-dimethylphenoxy group, a 2-tert-butyl-3-methylphenoxy group, a 2-tert-butyl-4-methylphenoxy group, a 2-tert-butyl-5-methylphenoxy group, a 2-tert-butyl-6-methylphenoxy group, a 2,3,4-trimethylphenoxy group, a 2,3,5-trimethylphenoxy group, a 2,3,6-trimethylphenoxy group, a 2,4,5-trimethylphenoxy group, a 2,4,6-trimethylphenoxy group, a 2-tert-butyl-3,4-dimethylphenoxy group, a 2-tert-butyl-3,5-dimethylphenoxy group, a 2-tert-butyl-3,6-dimethylphenoxy group, a 2,6-di-tert-butyl-3-methylphenoxy group, a 2-tert-butyl-4,5-dimethylphenoxy group, a 2,6-di-tert-butyl-4-methylphenoxy group, a 3, 4,5-trimethylphenoxy group, a 2,3,4,5-tetramethylphenoxy group, a 2-tert-butyl-3,4,5-trimethylphenoxy group, a 2,3,4,6-tetramethylphenoxy group, a 2-tert-butyl-3,4,6-trimethylphenoxy group, a 2,6-di-tert-butyl-3,4-dimethylphenoxy group, a 2,3,5,6-tetramethylphenoxy group, a 2-tert-butyl-3,5,6-trimethylphenoxy group, a 2,6-di-tert-butyl-3,5-dimethylphenoxy group, pentamethylphenoxy group, an ethylphenoxy group, a n-propylphenoxy group, an isopropylphenoxy group, a n-butylphenoxy group, a sec-butylphenoxy group, a tert-butylphenoxy group, a n-hexylphenoxy group, a n-octylphenoxy group, a n-decylphenoxy group, a n-tetradecylphenoxy group, a naphthoxy group, an anthracenoxy group and the like.

All of these aryloxy groups may be partially substituted with a halogen atom such as a fluorine atom, a chlorine atom, a bromine atom or an iodine atom, an alkoxy group such as a methoxy group, an ethoxy group or the like, an aryloxy group such as a phenoxy group or the like or an aralkyloxy group such as a benzyloxy group or the like, etc.

The di-substituted amino group in the substituent, X¹, is an amino group substituted with two hydrocarbon groups or silyl groups, and examples of the hydrocarbon group include alkyl groups having 1 to 10 carbon atoms such as a methyl group, an ethyl group, an-propyl group, an isopropyl group, an-butyl group, a sec-butyl group, a tert-butyl group, an isobutyl group, a n-pentyl group, a n-hexyl group, a cyclohexyl group and the like; aryl groups having 6 to 10 carbon atoms such as a phenyl group and the like; aralkyl groups having 7 to 10 carbon atoms such as a benzyl group and the like, etc. The silyl group include, for example, a trimethylsilyl group, tert-butyldimethylsilyl group and the like. Examples of such di-substituted amino group include a dimethylamino group, a diethylamino group, a di-n-propylamino group, a diisopropylamino group, a di-n-butylamino group, a di-sec-butylamino group, a di-tert-butylamino group, a di-isobutylamino group, a tert-butylisopropylamino group, a di-n-hexylamino group, a di-n-octylamino group, a diphenylamino group, a bistrimethylsilylamino group, a bis-tert-butyldimethylsilylamino group and the like, and a dimethylamino group, an diethylamino group, a diisopropylamino group, a di-tert-butylamino group, a bis-trimethylsilylamino group are preferred.

All of these di-substituted amino groups may be partially substituted with a halogen atom such as a fluorine atom, a chlorine atom, a bromine atom or an iodine atom, an alkoxy group such as a methoxy group, an ethoxy group or the like, an aryloxy group such as a phenoxy group or the like or an aralkyloxy group such as a benzyloxy group or the like, etc.

As the alkylthio group in the substituent, X¹, an alkylthio group having 1 to 20 carbon atoms is preferred, and examples include a methylthio group, an ethylthio group, a n-propylthio group, an isopropylthio group, a n-butylthio group, a sec-butylthio group, a tert-butylthio group, a n-pentylthio group, a neopentylthio group, a n-hexylthio group, a n-octylthio group, a n-dodecylthio group, a n-pentadecylthio group, a n-eicosylthio group and the like, and a methylthio group, an ethylthio group, an isopropylthio group or a tert-butylthio group is more preferable.

All of these alkylthio groups may be substituted with a halogen atom such as a fluorine atom, a chlorine atom, a bromine atom or an iodine atom. Further, all of these alkylthio groups may be partially substituted with an alkoxy group such as a methoxy group, an ethoxy group or the like, an aryloxy group such as a phenoxy group or the like or an aralkyloxy group such as a benzyloxy group or the like, etc.

As the aralkylthio group in the substituent, X¹, an aralkylthio group having 7 to 20 carbon atoms is preferable, and examples thereof include a benzylthio group, a (2-methylphenyl)methylthio group, a (3-methylphenyl)methylthio group, a (4-methylphenyl)methylthio group, a (2,3-dimethylphenyl)methylthio group, a (2,4-dimethylphenyl)methylthio group, a (2,5-dimethylphenyl)methylthio group, a (2,6-dimethylphenyl)methylthio group, a (3,4-dimethylphenyl)methylthio group, a (3,5-dimethylphenyl)methylthio group, a (2,3,4-timethylphenyl)methylthio group, a (2,3,5-timethylphenyl)methylthio group, a (2,3,6-timethylphenyl)methylthio group, a (2,4,5-timethylphenyl)methylthio group, a (2,4,6-timethylphenyl)methylthio group, a (3,4,3,5-timethylphenyl)methylthio group, a (2,3,4,5-tetramethylphenyl)methylthio group, a (2,3,4,6-tetramethylphenyl)methylthio group, a (2,3,5,6-tetramethylphenyl)methylthio group, a (pentamethylphenyl) methylthio group, an (ethylphenyl)methylthio group, a (n-propylphenyl)methylthio group, an (isopropylphenyl)methylthio group, a (n-butylphenyl)methylthio group, a (sec-butylphenyl)methylthio group, a (tert-butylphenyl)methylthio group, a (n-hexylphenyl)methylthio group, a (n-octylphenyl)methylthio group, a (n-decylphenyl)methylthio group, a naphthylmethylthio group, an anthracenylmethylthio group and the like, and a benzylthio group is more preferable.

All of these aralkylthio groups may be partially substituted with a halogen atom such as a fluorine atom, a chlorine atom, a bromine atom or an iodine atom, an alkoxy group such as a methoxy group, an ethoxy group or the like, an aryloxy group such as a phenoxy group or the like or an aralkyloxy group such as a benzyloxy group or the like, etc

As the arylthio group in the substituent, X^{l}, an arylthio group having 6 to 20 carbon atoms is preferable, and examples thereof include a phenylthio group, a 2-methyphenylthio group, a 3-methylphenylthio group, a 4-methylphenylthio group, a 2,3-dimethylphenylthio group, a 2,4-dimethylphenylthio group, a 2,5-dimethylphenylthio group, a 2,6-dimethylphenylthio group, a 3,4-dimethylphenylthio group, a 3,5-dimethylphenylthio group, a 2-tert-butyl-3-methylphenylthio group, a 2-tert-butyl-4-methylphenylthio group, a 2-tert-butyl-5-methylphenylthio group, a 2-tert-butyl-6-methylphenylthio group, a 2,3,4-trimethylphenylthio group, a 2,3,5-trimethylphenylthio group, a 2,3,6-trimethylphenylthio group, a 2,4,5-trimethylphenylthio group, a 2,4,6-trimethylphenylthio group, a 2-tert-butyl-3,4-dimethylphenylthio group, a 2-tert-butyl-3,5-dimethylphenylthio group, a 2-tert-butyl-3,6-dimethylphenylthio group, a 2,6-di-tert-butyl-3-methylphenylthio group, a 2-tert-butyl-4,5-dimethylphenylthio group, a 2,6-di-tert-butyl-4-methylphenylthio group, a 3,4,5-trimethylphenylthio group, a 2,3,4,5-tetramethylphenylthio group, a 2,3,4,6-tetramethylphenylthio group, a 2-tert-butyl-3,4,6-trimethylphenylthio group, a 2,6-di-tert-butyl-3,4-dimethylphenylthio group, a 2,3,5,6-tetramethylphenylthio group, a 2-tert-butyl-3,5,6-trimethylphenylthio group, a 2,6-di-tert-butyl-3,5-dimethylphenulthio group, a pentamethylphenylthio group, an ethylphenylthio group, a n-propylphenylthio group, an isopropylphenylthio group, a n-butylphenylthio group, a sec-butylphenylthio group, a tert-butylphenylthio group, a n-pentylphenylthio group, a neopentylphenylthio group, a n-hexylphenylthio group, a n-octylphenylthio group, a n-decylphenylthio group, a n-tetradecylphenylthio group, a naphthylthio group, an anthracenylthio group and the like.

All of these arylthio groups may be partially substituted with a halogen atom such as a fluorine atom, a chlorine atom, a bromine atom or an iodine atom, an alkoxy group such as a methoxy group, an ethoxy group or the like, an aryloxy group such as a phenoxy group or the like or an aralkyloxy group such as a benzyloxy group or the like.

As the alkylseleno group in the substituent, X¹, an alkyl group having 1 to 20 carbon atoms is preferred, and examples include a methylseleno group, an ethylseleno group, a n-propylseleno group, an isopropylseleno group, a n-butylseleno group, a sec-butylseleno group, a tert-butylseleno group, a n-pentylseleno group, a neopentylseleno group, a n-hexylseleno group, a n-octylseleno group, a n-dodecylseleno group, a n-pentadecylseleno group, a n-eicosylseleno group and the like, and a methylseleno group, an ethylseleno group, an isopropylseleno group or a tert-butylseleno group is more preferable.

All of these alkylseleno groups may be partially substituted with a halogen atom such as a fluorine atom, a chlorine atom, a bromine atom or an iodine atom, an alkoxy group such as a methoxy group, an ethoxy group or the like, an aryloxy group such as a phenoxy group or the like or an aralkyloxy group such as a benzyloxy group or the like.

As the aralkylseleno group in the substituent, X¹, an aralkylseleno group having 7 to 20 carbon atoms is preferable, and examples thereof include a benzylseleno group, a (2-methylphenyl)methylseleno group, a (3-methylphenyl)methylseleno group, a (4-methylphenyl)methylseleno group, a (2,3-dimethylphenyl)methylseleno group, a (2,4-dimethylphenyl)methylseleno group, a (2,5-dimethylphenyl)methylseleno group, a (2,6-dimethylphenyl)methylseleno group, a (3,4-dimethylphenyl)methylseleno group, a (3,5-dimethylphenyl)methylseleno group, a (2,3,4-timethylphenyl)methylseleno group, a (2,3,5-timethylphenyl)methylseleno group, a (2,3,6-timethylphenyl)methylseleno group, a (2,4, 5-timethylphenyl)methylseleno group, a (2,4,6-timethylphenyl)methylseleno group, a (3,4,5-timethylphenyl)methylseleno group, a (2,3,4,5-tetramethylphenyl)methylseleno group, a (2,3,4,6-tetramethylphenyl)methylseleno group, a (2,3,5,6-tetramethylphenyl)methylseleno group, a (pentamethylphenyl) methylseleno group, an (ethylphenyl)methylseleno group, a (n-propylphenyl)methylseleno group, an (isopropylphenyl)methylseleno group, a (n-butylphenyl)methylseleno group, a (sec-butylphenyl)methylseleno group, a (tert-butylphenyl)methylseleno group, a (n-hexylphenyl)methylseleno group, a (n-octylphenyl)methylseleno group, a (n-decylphenyl)methylseleno group, a naphthylmethylseleno group, an anthracenylmethylseleno group and the like, and a benzylseleno group is more preferable.

All of these aralkylseleno groups may be partially substituted with a halogen atom such as a fluorine atom, a chlorine atom, a bromine atom or an iodine atom, an alkoxy group such as a methoxy group, an ethoxy group or the like, an aryloxy group such as a phenoxy group or the like or an aralkyloxy group such as a benzyloxy group or the like.

As the arylseleno group in the substituent, X¹, an arylseleno group having 6 to 20 carbon atoms is preferable, and examples thereof include a phenylseleno group, a 2-methylphenylseleno group, a 3-methylphenylseleno group, a 4-methylphenylseleno group, a 2,3-dimethylphenylseleno group, a 2,4-dimethylphenylseleno group, a 2,5-dimethylphenylseleno group, a 2,6-dimethylphenylseleno group, a 3,4-dimethylphenylseleno group, a 3,5-dimethylphenylseleno group, a 2-tert-butyl- 3-methylphenylseleno group, a 2-tert -butyl -4-methylphenylseleno group, a 2-tert-butyl-5-methylphenylseleno group, a 2-tert-butyl- 6-methylphenylseleno group, a 2,3,4-trimethylphenylseleno group, a 2,3,5-trimethylphenylseleno group, a 2,3,6-trimethylphenylseleno group, a 2,4,5-tri methylphenylseleno group, a 2,4,6-tri methylphenylseleno group, a 2-tert-butyl-3,4-dimethylphenylseleno group, a 2-tert-butyl-3,5-dimethylphenylseleno group, a 2-tert-butyl-3,6-dimethylphenylseleno group, a 2,6-di-tert-butyl-3-methylphenylseleno group, a 2-tert-butyl-4,5-dimethylphenylseleno group, a 2,6-di-tert-butyl-4-methylphenylseleno group, a 3,4,5-trimethylphenylseleno group, a 2,3,4,5-tetramethylphenylseleno group, a 2,3,4,6-tetramethylphenylseleno group, a 2-tert-butyl-3,4,6-trimethylphenylseleno group, a 2,6-di-tert-butyl-3,4-dimethylphenylseleno group, a 2,3,5,6-tetramethylphenylseleno group, a 2-tert-butyl-3,5,6-trimethylphenylseleno group, a 2,6-di-tert-butyl-3,5-dimethylphenulseleno group, a pentamethylphenylseleno group, an ethylphenylseleno group, a n-propylphenylseleno group, an isopropylphenylseleno group, a n-butylphenylseleno group, a sec-butylphenylseleno group, a tert-butylphenylseleno group, a n-pentylphenylseleno group, a neopentylphenylseleno group, a n-hexylphenylseleno group, a n-octylphenylseleno group, a n-decylphenylseleno group, a n-tetradecylphenylseleno group, a naphthylseleno group, an anthracenylseleno group and the like.

All of these arylseleno groups may be partially substituted with a halogen atom such as a fluorine atom, a chlorine atom, a bromine atom or an iodine atom, an alkoxy group such as a methoxy group, an ethoxy group or the like, an aryloxy group such as a phenoxy group or the like or an aralkyloxy group such as a benzyloxy group or the like.

X¹ is preferably a halogen atom, an alkyl group, an aralkyl group, an alkoxy group, an aryloxy group or a di-substituted amino group, and more preferably a halogen atom, an alkyl group, an alkoxy group or an aryloxy group.

X² in the general formula (I) or (II) represents an atom of Group XVI of the Periodic Table of the Elements, and specific examples thereof include an oxygen atom, a sulfur atom and a selenium atom, an oxygen atom or a sulfur atom is preferable and an oxygen atom is more preferable.

In the general formula (I) or (II) above, Cp may be bonded to X¹ directly or trough a bridging group. The bridging group includes a divalent bridging group containing an atom of the Group XIV of the Periodic Table of the Elements and the like, preferably a divalent bridging group containing a carbon atom or silicon group, more preferably a divalent bridging group in which an atom bonded to Cp and X1 is a carbon atom and/or silicon atom, further preferably a divalent bridging group in which an atom bonded to Cp and X¹ is a carbon atom and/or silicon atom and in which Cp is bonded to X¹ through at most 3 atoms. Specific examples thereof include a methylene group, ethylene group, propylene group, dimethylmethylene group(isopropylidene group), diphenylmethylene group, tetramethylethylene group, silylene group, dimethylsilylene group, diethylsilylene group, diphenylsilylene group, tetramethyldisilylene group, dimethoxysilylene group and the like, preferably a methylene group, ethylene group, dimethylmethylene group, dimethylsilylene group, diethylsilylene group and diphenylsilylene group. Preferably, the transition metal compound represented by the general formula(I) or (II) is a transition metal compound in which Cp is bonded to X¹ trough a bridging group.

As the transition metal compound used in the present invention, a transition metal compound represented by the general formula (III) or (IV) below is more preferable:

CpYMX¹₂ (III)

(CpYMX¹ₙ)₂X²₂₋ₙ (IV)

(wherein respective M, Cp, X¹ and X² is the same as defined in the general formula (I) or (II) above; Y is a group having at least one atom of the Group XV or XVI of the Periodic Table of the Elements and σ-bonding to M through the atom in the group; Cp and X¹ may be bonded each other directly or through a bridging group; n is 0 or 1; and a plurarity of respective Cp, M, X¹ and X² may be the same or different.)

Y in the formula (III) or (IV) represents a group having an atom of the Group XV or XVI of the Periodic Table of the Elements and σ-bonding to M through the atom in the group, for example, a group having an oxygen atom, nitrogen atom, sulfur atom or phosphorus atom and σ-bonding to M through the atom in the group, respectively, preferably having an oxygen atom or nitrogen atom and σ-bonding to M through the oxygen atom or nitrogen atom.

In the general formula (III) or (IV) described above, respective Cp and Y are bonded each other directly or through a bridging group. The bridging group includes a divalent bridging group containing at least one atom of the Group XIV, XV or XVI of the Periodic Table of the Elements (Revised edition of IUPAC Inorganic Chemistry Nomenclature 1989), preferably a divalent bridging group containing a carbon atom and/or silicon atom, more preferably a divalent bridging group in which an atom bonding to Cp or Y is a carbon atom or silicon atom, and particularly preferably a divalent bridging group in which an atom bonding to Cp or Y is a carbon atom or silicon atom, and in which Cp is bonded to Y through at most 3 atoms. Example of the divalent bridging group include the following divalent groups:

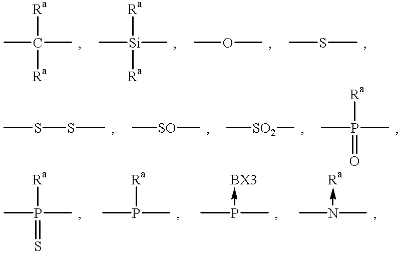

and the like.

Wherein, R^{a} represents a halogen atom, an alkyl group having 1 to 20 carbon atoms, which may be substituted with a halogen atom, an aralkyl group having 7 to 20 carbon atoms, which may be substituted with a halogen atom or an aryl group having 6 to 20 carbon atoms, which may be substituted with a halogen atom, and X represents a hydrogen atom or halogen atom.

Specific examples thereof preferably include a methylene group, ethylene group, propylene group, dimethylmethylene group(isopropylidene group), diphenylmethylene group, tetramethylethylene group, silylene group, dimethylsilylene group, diethylsilylene group, diphenylsilylene group, tetramethyldisilylene group, dimethoxysilylene group and the like, more preferably a methylene group, ethylene group, dimethylmethylene group, dimethylsilylene group, diethylsilylene group and diphenylsilylene group.

As Y, examples of a group σ-bonding to M through an oxygen atom include —O—, an alkoxy group, aryloxy group and aralkyloxy group, and specific examples include —O— and the same examples as those listed in the alkoxy group, aryloxy group and aralkyloxy group of X¹. Herein, —O— means that an oxygen atom is σ-bonded to M and is bonded to Cp through a bridging group.

As Y, examples of a group σ-bonding to M through a nitrogen atom include a mono-substituted amino group and di-substituted amino group, and specific examples include the same examples as those listed in the di-substituted amino group of X¹.

As a substituent, Y, a mono-substituted group is an amino group substituted with one hydrocarbon or silyl group, and the hydrocarbon group includes an alkyl group having 1 to 10 carbon atoms such as a methyl group, ethyl group, n-propyl group, isopropyl group, n-butyl group, sec-butyl group, tert-butyl group, isobutyl group, n-pentyl group, n-hexyl group, cyclohexyl group and the like; an aryl group having 6 to 10 carbon atoms such as phenyl group and the like; and an aralkyl group having 7 to 10 carbon atoms such as benzyl group and the like. Examples of the silyl group include trimethylsilyl group, tert-butyldimethylsilyl group and the like. Examples of the mono-substituted amino group include, for example, a methylamino group, ethylamino group, n-propylamino group, isopropylamino group, n-butylamino group, sec-butylamino group, tert-butylamino group, isobutylamino group, n-pentylamino group, n-hexylamino group, n-octylamino group, phenylamino group, trimethylsilyl amino group, tert-butyldimethylsilylamino group and the like, and preferably a methylamino group, ethylamino group, isopropylamino group, tert-butylamino group and trimethylsilyl amino group. These mono-substituted amino group may be partially substituted with a halogen atom such as a fluorine atom, chlorine atom, bromine atom and iodine atom, an alkoxy group such as methoxy group, ethoxy group and the like, an aryloxy group such as phenoxy group and the like and an aralkyloxy group such as benzyloxy group and the like.

In the mono-substituted amino group as Y, the nitrogen atom is σ-bonded to M and is bonded to Cp through a bridging group.

Specific examples of the transition metal compound represented by the general formula (III) or (IV) include dimethylsilylene(methylamino)(cyclopentadienyl)titanium dichloride, dimethylsilylene(tert-butylamino) (cyclopentadienyl)titanium dichloride, dimethylsilylene (phenylamino)(cyclopentadienyl)titanium dichloride, dimethylsilylene(cyclohexylamino)(cyclopentadienyl) titanium dichloride and the like, compounds in which cyclopentadienyl in the above-compounds is replaced with methylcyclopentadienyl, tetramethylcyclopentadienyl, ethylcyclopentadienyl, n-butylcyclopentadienyl, tert-butylcyclopentadienyl, di-tert-butylcyclopentadienyl, tert-butylmethylsilylcyclopentadienyl, phenylcyclopentadienyl, ethyindenyl, phenylindenyl or- fluorenyl, compounds in which dimethylsilylene in the above-compounds is replaced with dimethylsilylene, diphenylsilylene, methylene, ethylene or isopropylidene, compounds in which titanium in the above-compounds is replaced with zirconium or hafnium, and compounds in which dichloride in the above-compounds is replaced with dimethyl, dimethoxide, bis(dimethylamido) or bis(diethylamide); μ-oxobis{dimethylsilylene(methylamino)(cyclopentadienyl) titanium chloride}, μ-oxobis{dimethylsilylene(tert-butylamino) (cyclopentadienyl)titanium chloride}, μ-oxobis{dimethylsilylene (phenylamino)(cyclopentadienyl)titanium chloride}, μ-oxobis{dimethylsilylene(cyclohexylamino)(cyclopentadie nyl) titanium chloride} and the like, compounds in which cyclopentadienyl in the above-compounds is replaced with methylcyclopentadienyl, tetramethylcyclopentadienyl, ethylcyclopentadienyl, n-butylcyclopentadienyl, tert-butylcyclopentadienyl, di-tert-butylcyclopentadienyl, tert-butylmethylsilylcyclopentadienyl, phenylcyclopentadienyl, ethyindenyl, phenylindenyl or fluorenyl, compounds in which dimethylsilylene in the above-compounds is replaced with dimethylsilylene, diphenylsilylene, methylene, ethylene or isopropylidene, compounds in which titanium in the above-compounds is replaced with zirconium or hafnium, and compounds in which chloride in the above-compounds is replaced with methyl, methoxide, dimethylamido or diethylamide; and di-μ-oxobis{dimethylsilylene(methylamino)(cyclopentadienyl) titanium}, di-μ-oxobis{dimethylsilylene(tert-butylamino) (cyclopentadienyl)titanium}, di-μ-oxobis{dimethylsilylene (phenylamino)(cyclopentadienyl)titanium}, di-μ-oxobis{dimethylsilylene(cyclohexylamino)(cyclopentadie nyl)titanium} and the like, compounds in which cyclopentadienyl in the above-compounds is replaced with methylcyclopentadienyl, tetramethylcyclopentadienyl, ethylcyclopentadienyl, n-butylcyclopentadienyl, tert-butylcyclopentadienyl, di-tert-butylcyclopentadienyl, tert-butylmethylsilylcyclopentadienyl, phenylcyclopentadienyl, ethyindenyl, phenylindenyl or fluorenyl, compounds in which dimethylsilylene in the above-compounds is replaced with dimethylsilylene, diphenylsilylene, methylene, ethylene or isopropylidene, and compounds in which titanium in the above-compounds is replaced with zirconium or hafnium.

More preferable transition metal compound used in the present invention include transition metal compounds represented by the general formulas (V), (VI) and (VII);

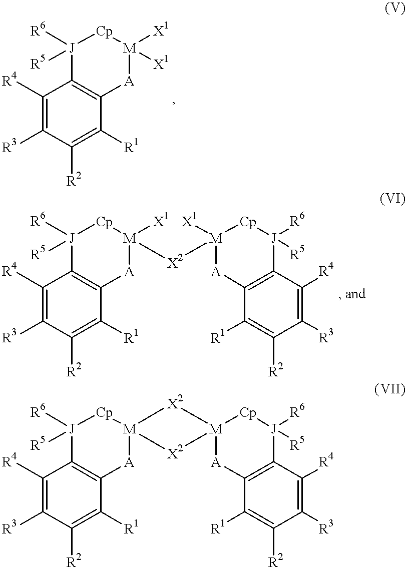

wherein, in the general formula (V), (VI) or (VII), M represents a transition metal atom of the Group IV of the Periodic Table of the Elements; A represents an atom of the Group XVI of the Periodic Table of the Elements; J represents an atom of the Group XIV of the Periodic Table of the Elements; 10 Cp represents a group having a cyclopentadiene type anion skeleton; each of X¹, R¹, R², R³, R⁴, R⁵ and R⁶ independently represents a hydrogen atom, a halogen atom, an alkyl group, an aralkyl group, an aryl group, a substituted silyl group, an alkoxy group, an aralkyloxy group, an aryloxy group, a di-substituted amino group, an alkylthio group, an aralkylthio group, an arylthio group, an alkylseleno group, an aralkylseleno group or arylseleno group; X² represents an atom of Group XVI of the Periodic Table of the Elements; R¹, R², R³, R⁴, R⁵ and R⁶ may be optionally combined with each other to form a ring; and in the general formula (VI) or (VII), two of M, A, J, Cp, X¹, X², R¹, R², R³, R⁴, R⁵ and R⁶ may be respectively the same or different.),

M, Cp, and X² in the general formula (V), (VI) or (VII) are the same as those defined in the general formula (I) or (II) described above. And, each of X¹, X², R¹, R², R³, R⁴, R⁵ and R⁶ in the general formula (V), (VI) or (VII) is independently the same as X¹ defined in the general formula (I) or (II) described above.

Further, each of R¹, R², R³ and R⁴ is independently preferably a hydrogen atom, halogen atom, alkyl group, aralkyl group, aryl group, substituted silyl group, alkoxy group, aralkyloxy group or aryloxy group, and among these, alkyl group, aralkyl group, aryl group or substituted silyl group as R¹ are more preferable.

Moreover, each of R⁵ and R⁶ in the general formula (V), (VI) or (VII), is independently preferably a hydrogen atom, alkyl group, aralkyl group, aryl group, substituted silyl group, alkoxy group, aralkyloxy group or aryloxy group.

Furthermore, A in the general formula (V), (VI) or (VII), is an atom of the Group XVI of the Periodic Table of the Elements such as an oxygen atom, sulfur atom, selenium atom or the like, preferably an oxygen atom.

J in the general formula (V), (VI) or (VII), represents a transition metal atom of the Group IV of the Periodic Table of the Elements such as a carbon atom, silicon atom, germanium atom and the like, and preferably a carbon atom and silicon atom.

As such transition metal compounds, specific examples of those represented by the general formula (V) include methylene(η⁵-cyclopentadienyl)(3,5-dimethyl-2-phenoxy)titanium dichloride, methylene(η⁵-cyclopentadienyl) (3-tert-butyl-2-phenoxy)titaniumdichloride, methylene(η⁵-cyclopentadienyl)(3-tert-butyl-5-methyl-2-phenoxy)titanium dichloride, methylene(η⁵-cyclopentadienyl)(3-phenyl-2-phenoxy)titanium dichloride, methylene(η⁵-cyclopentadienyl)(3-tert-butyldimethylsilyl-5-methyl-2-phenoxy)titanium dichloride, methylene(η⁵-cyclopentadienyl)(3-trimethylsilyl-5-methyl-2-phenoxy) titanium dichloride, methylene(η⁵-cyclopentadienyl)(3-tert-butyl-5-methoxy-2-phenoxy)titanium dichloride, methylene(η⁵-cyclopentadienyl)(3-tert-butyl-5-chloro-2-phenoxy)titanium dichloride, methylene(η⁵-tetramethylcyclopentadienyl)(3,5-dimethyl-2-phenoxy)titanium dichloride, methylene(η⁵-tetramethylcyclopentadienyl)(3-tert-butyl-2-phenoxy)titanium dichloride, methylene(η⁵-tetramethylcyclopentadienyl)(3-tert-butyl-5-methyl-2-phenoxy)titanium dichloride, methylene(η⁵-tetramethylcyclopentadienyl)(3-phenyl-2-phenoxy)titanium dichloride, methylene(η⁵-tetramethylcyclopentadienyl)(3-tert-butyldimethylsily 1-5-methyl-2-phenoxy)titanium dichloride, methylene(η⁵-tetramethylcyclopentadienyl)(3-trimethylsilyl-5-methy 1-2-phenoxy)titanium dichloride, methylene(η⁵-tetramethylcyclopentadienyl)(3-tert-butyl-5-methoxy-2-phenoxy)titanium dichloride, methylene(η⁵-tetramethylcyclopentadienyl)(3-tert-butyl-5-chloro-2-phenoxy)titanium dichloride, isopropylidene(η⁵-cyclopentadienyl)(3,5-dimethyl-2-phenoxy)titanium dichloride, isopropylidene(η⁵-cyclopentadienyl)(3-tert-butyl-2-phenoxy)titanium dichloride, isopropylidene(η⁵-cyclopentadienyl)(3-tert-butyl-5-methyl-2-phenoxy)titanium dichloride, isopropylidene (η⁵-cyclopentadienyl)(3-phenyl-2-phenoxy)titanium dichloride, isopropylidene(η⁵-cyclopentadienyl)(3-tert-butyldimethylsilyl-5-methyl-2-phenoxy)titanium dichloride, isopropylidene(η⁵-cyclopentadienyl)(3-trimethylsilyl-5-methyl-2-phenoxy)titanium dichloride, isopropylidene(η⁵-cyclopentadienyl)(3-tert-butyl-5-methoxy-2-phenoxy)titanium dichloride, isopropylidene (η⁵-cyclopentadienyl)(3-tert-butyl-5-chloro-2-phenoxy)titanium dichloride, isopropylidene(η⁵-tetramethylcyclopentadienyl)(3,5-dimethyl-2-phenoxy)titanium dichloride, isopropylidene(η⁵-tetramethylcyclopentadienyl)(3-tert-butyl-2-phenoxy)titanium dichloride, isopropylidene(η⁵-tetramethylcyclopentadienyl)(3-tert-butyl-5-methyl-2-phenoxy)titanium dichloride, isopropylidene(η⁵-tetramethylcyclopentadienyl)(3-phenyl-2-phenoxy)titanium dichloride, isopropylidene(η⁵-tetramethylcyclopentadienyl)(3-tert-butyldimethylsily 1-5-methyl-2-phenoxy)titanium dichloride, isopropylidene(η⁵-tetramethylcyclopentadienyl)(3-trimethylsilyl-5-methy 1-2-phenoxy)titanium dichloride, isopropylidene(η⁵-tetramethylcyclopentadienyl)(3-tert-butyl-5-methoxy-2-phenoxy)titanium dichloride, isopropylidene (η⁵-tetramethylcyclopentadienyl)(3-tert-butyl-5-chloro-2-phenoxy)titanium dichloride, diphenylmethylene(η⁵-cyclopentadienyl)(3,5-dimethyl-2-phenoxy)titanium dichloride, diphenylmethylene(η⁵-cyclopentadienyl)(3-tert-butyl-2-phenoxy)titanium dichloride, diphenylmethylene(η⁵-cyclopentadienyl)(3-tert-butyl-5-methyl-2-phenoxy)titanium dichloride, diphenylmethylene(η⁵-cyclopentadienyl)(3-phenyl-2-phenoxy)titanium dichloride, diphenylmethylene(η⁵-cyclopentadienyl)(3-tert-butyldimethylsilyl-5-methyl-2-phenoxy)titanium dichloride, diphenylmethylene(η⁵-cyclopentadienyl)(3-trimethylsilyl-5-methyl-2-phenoxy)titanium dichloride, diphenylmethylene(η⁵cyclopentadienyl)(3-tert-butyl-5-methoxy-2-phenoxy)titanium dichloride, diphenylmethylene(η⁵-cyclopentadienyl)(3-tert-butyl-5-chloro-2-phenoxy)titanium dichloride, diphenylmethylene(η⁵-tetramethylcyclopentadienyl)(3,5-dimethyl-2-phenoxy)titanium dichloride, diphenylmethylene(η⁵-tetramethylcyclopentadienyl)(3-tert-butyl-2-phenoxy)titanium dichloride, diphenylmethylene(η⁵-tetramethylcyclopentadienyl)(3-tert-butyl-5-methyl-2-phenoxy)titanium dichloride, diphenylmethylene(η⁵-tetramethylcyclopentadienyl)(3-phenyl-2-phenoxy)titanium dichloride, diphenylmethylene(η⁵-tetramethylcyclopentadienyl)(3-tert-butyldimethylsily 1-5-methyl-2-phenoxy)titanium dichloride, diphenylmethylene(η⁵-tetra methylcyclopentadienyl)(3-trimethylsilyl-5-methyl-2-phenoxy)titanium dichloride, diphenylmethylene(η⁵-tetramethylcyclopentadienyl)(3-tert-butyl-5-methoxy-2-phenoxy)titanium dichloride, diphenylmethylene(η⁵-tetramethylcyclopentadienyl)(3-tert-butyl-5-chloro-2-phenoxy) titanium dichloride and the like; compounds in which titanium of these compounds is replaced with zirconium or hafnium; compounds in which dichloride of these compounds is replaced by dimethyl, dibenzyl, dimethoxide, diphenoxide, bis(dimethylamino) or bis(diethylamino); compounds in which (η⁵-cyclopentadienyl) of these compounds is replaced with (η⁵-methylcyclopentadienyl), (η⁵-dimethylcyclopentadienyl), (η⁵-trimethylcyclopentadienyl), (η⁵-n-butylcyclopentadienyl), ), (η⁵-tert-butylcyclopentadienyl),(η⁵-trimethylsilylcyclopentadienyl), (η⁵-tert-butyldimethylsilylcyclopentadienyl), (η⁵-indenyl), (η⁵-methylindenyl), (η⁵-phenylindenyl) or (η⁵-fluorenyl); compounds in which (3,5-dimethyl-2-phenoxy) of these compounds is replaced with (2-phenoxy), (3-methyl-2-phenoxy), (3,5-di-tert-butyl-2-phenoxy), (3-phenyl-5-methyl-2-phenoxy), (3-tert-butyldimethylsilyl-2-phenoxy) or (3-trimethylsilyl-2-phenoxy);

Furthermore, dimethylsilylene (η⁵-cyclopentadienyl)(2-phenoxy)titanium dichloride, dimethylsilylene(η⁵-cyclopentadienyl) (3-methyl-2-phenoxy)titanium dichloride, dimethylsilylene(η⁵⁻cyclopentadienyl) (3,5-dimethyl-2-phenoxy)titanium dichloride, dimethylsilylene(η⁵-cyclopentadienyl) (3-tert-butyl-2-phenoxy)titanium dichloride, dimethylsilylene(η⁵-cyclopentadienyl) (3-tert-butyl-5-methyl-2-phenoxy)titanium dichloride, dimethylsilylene(η⁵-cyclopentadienyl) (3,5-di-tert-butyl-2-phenoxy)titanium dichloride, dimethylsilylene(η⁵-cyclopentadienyl) (5-methyl-3-phenyl-2-phenoxy)titanium dichloride, dimethylsilylene(η⁵-cyclopentadienyl) (3-tert-butyldimethylsilyl-5-methyl-2-phenoxy)titanium dichloride, dimethylsilylene(η⁵-cyclopentadienyl)(5-methyl-3-trimethylsilyl-2-phenoxy)titanium dichloride, dimethylsilylene(η⁵-cyclopentadienyl)(3-tert-butyl-5-methoxy-2-phenoxy)titanium dichloride, dimethylsilylene(η⁵-cyclopentadienyl)(3-tert-butyl-5-chloro-2-phenoxy)titanium dichloride, dimethylsilylene(η⁵-cyclopentadienyl)(3,5-di-sec-amyl-2-phenoxy)titanium dichloride, dimethylsilylene(η⁵-cyclopentadienyl) (1-naphtoxy-2-yl)titanium dichloride, dimethylsilylene (η⁵-tetramethylcyclopentadienyl)(2-phenoxy)titanium dichloride, dimethylsilylene(η⁵-tetramethylcyclopentadienyl)(3-methyl-2-phenoxy)titanium dichloride, dimethylsilylene(η⁵-tetramethylcyclopentadienyl)(3,5-dimethyl-2-phenoxy)titanium dichloride, dimethylsilylene(η⁵-tetramethylcyclopentadienyl)(3-tert-butyl-2-phenoxy)titanium dichloride, dimethylsilylene(η⁵-tetramethylcyclopentadienyl)(3-tert-butyl-5-methyl-2-phenoxy)titanium dichloride, dimethylsilylene(η⁵-tetramethylcyclopentadienyl)(3,5-di-tert-butyl-2-phenoxy)titanium dichloride, dimethylsilylene(η⁵-tetramethylcyclopentadienyl)(5-methyl-3-phenyl-2-phenoxy)titanium dichloride, dimethylsilylene(η⁵-tetramethylcyclopentadienyl)(3-tert-butyldimethylsily 1-5-methyl-2-phenoxy)titanium dichloride, dimethylsilylene(η⁵-tetramethylcyclopentadienyl) (5-methyl-3-trimethylsilyl-2-phenoxy)titanium dichloride, dimethylsilylene(η⁵-tetramethylcyclopentadienyl) (3-tert-butyl-5-methoxy-2-phenoxy)titanium dichloride, dimethylsilylene(η⁵-tetramethylcyclopentadienyl) (3-tert-butyl-5-chloro-2-phenoxy)titanium dichloride, dimethylsilylene(η⁵-tetramethylcyclopentadienyl) (3,5-di-sec-amyl-2-phenoxy)titanium dichloride, and dimethylsilylene(η⁵-tetramethylcyclopentadienyl) (1-naphtoxy-2-yl) titanium dichloride; compounds wherein (η⁵-cyclopentadienyl) of these compounds is replaced by (η⁵-methylcyclopentadienyl), (η⁵-dimethylcyclopentadienyl), (η⁵-trimethylcyclopentadienyl), (η⁵-ethylcyclopentadienyl), (η⁵-n-propylcyclopentadienyl), (η⁵-isopropylcyclopentadienyl), (η⁵-n-butylcyclopentadienyl), (η⁵-sec-butylcyclopentadienyl), (η⁵-isobutylcyclopentadienyl), (η⁵-tert-butylcyclopentadienyl), (η⁵-trimethylsilylcyclopentadienyl), (η⁵-tert-butyldimethylsilylcyclopentadienyl), (η⁵-phenylcyclopentadienyl), (η⁵-indenyl), (η⁵-methylindenyl), (η⁵-phenylindenyl) or (η⁵-fluorenyl);

compounds wherein (2-phenoxy) of these compounds is replaced with (3-phenyl-2-phenoxy), (3-trimethylsilyl-2-phenoxy) or (3-tert-butyldimethylsilyl-2-phenoxy); compounds in which dimethylsilylene of these compounds is replaced with diethylsilylene, diphenylsilylene or dimethoxysilylene; compounds in which titanium of these compounds is replaced with zirconium or hafnium; and compounds in which dichloride of these compounds is replaced with dimethyl, dibenzyl, dimethoxide, diphenoxide, bis(dimethylamino) or bis(diethylamino); and the like.

Specific examples of the transition metal compound represented by the general formula (VI) include μ-oxobis{isopropylidene(η⁵-cyclopentadienyl) (2-phenoxy)titaniumchloride}, μ-oxobis{isopropylidene(η⁵-cyclopentadienyl)(2-phenoxy)titanium methoxide}, μ-oxobis{isopropylidene(η⁵-cyclopentadienyl) (3-tert-butyl-5-methyl-2-phenoxy)titanium chloride}, μ-oxobis{isopropylidene(η⁵-cyclopentadienyl) (3-tert-butyl-5-methyl-2-phenoxy)titanium methoxide}, μ-oxobis{isopropylidene(η⁵-methylcyclopentadienyl) (2-phenoxy)titanium chloride}, μ-oxobis{isopropylidene (η⁵-methylcyclopentadienyl) (2-phenoxy)titanium methoxide}, μ-oxobis{isopropylidene(η⁵-methylcyclopentadienyl)(3-tert-butyl-5-methyl-2-phenoxy)titanium chloride}, μ-oxobis{isopropylidene (η⁵-methylcyclopentadienyl) (3-tert-butyl-5-methyl-2-phenoxy)titanium methoxide}, μ-oxobis{isopropylidene (η⁵-tetramethylcyclopentadienyl)(2-phenoxy)titanium chloride}, μ-oxobis{isopropylidene(η⁵-tetramethylcyclopentadienyl)(2-phenoxy)titanium methoxide}, μ-oxobis{isopropylidene(η⁵-tetramethylcyclopentadienyl)(3-tert-butyl-5-methyl-2-phenoxy)titanium chloride}, μ-oxobis{isopropylidene (η⁵-tetramethylcyclopentadienyl) (3-tert-butyl-5-methyl-2-phenoxy)titanium methoxide}, μ-oxobis{dimethylsilylene(η⁵-cyclopentadienyl)(2-phenoxy)titanium chloride}, μ-oxobis{dimethylsilylene(η⁵-cyclopentadienyl)(2-phenoxy)titanium methoxide}, μ-oxobis{dimethylsilylene(η⁵-cyclopentadienyl)(3-tert-butyl-5-methyl-2-phenoxy)titanium chloride}, μ-oxobis{dimethylsilylene(η⁵-cyclopentadienyl)(3-tert-butyl-5-methyl-2-phenoxy)titanium methoxide}, μ-oxobis{dimethylsilylene(η⁵-methylcyclopentadienyl)(2-phenoxy)titanium chloride}, μ-oxobis{dimethylsilylene(η⁵-methylcyclopentadienyl) (2-phenoxy) titanium methoxide}, μ-oxobis{dimethylsilylene(η⁵-methylcyclopentadienyl)(3-tert-butyl-5-methyl-2-phenoxy)titanium chloride}, μ-oxobis{dimethylsilylene(η⁵-methylcyclopentadienyl)(3-tert-butyl-5-methyl-2-phenoxy)titanium methoxide}, μ-oxobis{dimethylsilylene(η⁵-tetramethylcyclopentadienyl)(2-phenoxy)titanium chloride}, μ-oxobis{dimethylsilylene(η⁵-tetramethylcyclopentadienyl)(2-phenoxy)titanium methoxide}, μ-oxobis{dimethylsilylene(η⁵-tetramethylcyclopentadienyl)(3-tert-butyl-5-methyl-2-phenoxy)titanium chloride}, μ-oxobis{dimethylsilylene(η⁵-tetramethylcyclopentadienyl)(3-tert-butyl-5-methyl-2-phenoxy)titanium methoxide}; compounds in which titanium of these compounds is replaced with zirconium or hafnium; compounds in which chloride of these compounds is replaced with methyl, benzyl, phenoxide, dimethylamino or diethylamino; compounds in which (η⁵-cyclopentadienyl) of these compounds is replaced with (η⁵-dimethylcyclopentadienyl),(η⁵-trimethylcyclopentadienyl), (η⁵-n-butylcyclopentadienyl), (η⁵-tert-butylcyclopentadienyl), (η⁵-trimethylsilylcyclopentadienyl), (η⁵-tert-butyldimethylsilylcyclopentadienyl),(η⁵-indenyl), (η⁵-methylindenyl), (η⁵-phenylindenyl) or (η⁵-fluorenyl); and compounds in which (2-phenoxy) of these compounds is replaced with (3-methyl-2-phenoxy), (3,5-dimethyl-2-phenoxy), (3,5-di-tert-butyl-2-phenoxy), (3-phenyl-5-methyl-2-phenoxy) or (3-trimethylsilyl-5-methyl-2-phenoxy).

Specific examples of the transition metal compound represented by the general formula (VII) include di-μ-oxobis{isopropylidene(η⁵-cyclopentadienyl) (2-phenoxy)titanium}, di-μ-oxobis{isopropylidene(η⁵-cyclopentadienyl)(3-tert-butyl-5-methyl-2-phenoxy)titanium}, di-μ-oxobis{isopropylidene(η⁵-methylcyclopentadienyl)(2-phenoxy)titanium}, di-μ-oxobis{isopropylidene(η⁵-methylcyclopentadienyl) (3-tert-butyl-5-methyl-2-phenoxy)titanium}, di-μ-oxobis{isopropylidene(η⁵-tetramethylcyclopentadienyl) (2-phenoxy)titanium}, di-μ-oxobis{isopropylidene(η⁵-tetramethyl cyclopentadienyl) (3-tert-butyl-5-methyl-2-phenoxy)titanium}, di-μ-oxobis{dimethylsilylene (η⁵-cyclopentadienyl) (2-phenoxy)titanium}, di-μ-oxobis{dimethylsilylene(η⁵-cyclopentadienyl)(3-tert-butyl-5-methyl-2-phenoxy)titanium}, di-μ-oxobis{dimethylsilylene(η⁵-methylcyclopentadienyl) (2-phenoxy)titanium}, di-μ-oxobis{dimethylsilylene (η⁵-methylcyclopentadienyl) (3-tert-butyl-5-methyl-2-phenoxy)titanium}, di-μ-oxobis{dimethylsilylene(η⁵-tetramethylcyclopentadienyl)(2-phenoxy)titanium}, di-μ-oxobis{dimethylsilylene(η⁵-tetramethyl cyclopentadienyl)(3-tert-butyl-5-methyl-2-phenoxy)titanium}; compounds in which titanium of these compounds is replaced with zirconium or hafnium; compounds in which (η⁵-cyclopentadienyl) of these compounds is replaced with (η⁵-dimethylcyclopentadienyl),(η⁵-trimethylcyclopentadienyl), (η⁵-n-butylcyclopentadienyl), (η⁵-tert-butylcyclopentadienyl), (η⁵-trimethylsilylcyclopentadienyl), (η⁵-tert-butyldimethylsilylcyclopentadienyl), (η⁵-indenyl), (η⁵-methylindenyl), (η⁵-phenylindenyl) or (η⁵-fluorenyl); and compounds in which (2-phenoxy) of these compounds is replaced with (3-methyl-2-phenoxy), (3,5-dimethyl-2-phenoxy), (3,5-di-tert-butyl-2-phenoxy), (3-phenyl-5-methyl-2-phenoxy) or (3-trimethylsilyl-5-methyl-2-phenoxy); and the like.

These transition metal compounds can be synthesized by a known method.

(B) Aluminum Compound

The aluminum compound(B) used in the present invention is an aluminum compound selected from the following (B1) to (B3);

(B1) an organoaluminum compound represented by the general formula E¹ₐAlZ₃₋ₐ,

(B2) a cyclic aluminoxane having a structure represented by the general formula {—Al(E²)—O—}_{b}, and

(B3) a linear aluminoxane having a structure represented by the general formula E³{—Al(E³)—O—}_{c}AlE³₂

(wherein E¹, E² and E³ respectively represent a hydrocarbon group, all of E¹, E² and E³ may be the same or different, Z represents a hydrogen atom or a halogen atom, and all of Z may be the same or different, a represents a numeral satisfying 0<a≦3, b represents an integer of not less than 2, and c represents an integer of not less than 1.)

As the hydrocarbon group in E¹, E² or E³, a hydrocarbon group having 1 to 8 carbon atoms is preferable and an alkyl group is more preferable.

Specific examples of the organoaluminum compound (B1), represented by the general formula EₐAlZ₃₋ₐ include trialkylaluminums such as trimethylaluminum, triethylaluminum, tri-n-propylaluminum, triisopropylaluminum, triisobutylaluminum, tri-n-hexylaluminum and the like; dialkylaluminum chlorides such as dimethylaluminum chloride, diethylaluminum chloride, di-n-propylaluminumchloride, diisopropylaluminumchloride, diisobutylaluminum chloride, di-n-hexylaluminum chloride and the like; alkylaluminum dichlorides such as methylaluminum dichloride, ethylaluminum dichloride, n-propylaluminumdichloride, isopropylaluminumdichloride, isobutylaluminum dichloride, n-hexylaluminum dichloride and the like; and dialkylaluminum hydrides such as dimethylaluminum hydride, diethylaluminum hydride, di-n-propylaluminum hydride, diisopropylaluminum hydride, diisobutylaluminum hydride, di-n-hexylaluminum hydride and the like, etc. Trialkylaluminums are preferable, and triethylaluminum and triisobutylaluminum are more preferred.

Specific examples of E² and E³ in the cyclic aluminoxane (B2) having a structure represented by the general formula {—Al(E²)—O—}_{b} and the linear aluminoxane (B3) having a structure represented by the general formula E³—{Al(E³)—O—}_{c}AlE³₂include alkyl groups such as a methyl group, an ethyl group, a n-propyl group, an isopropyl group, a n-butyl group, an isobutyl group, a n-pentyl group, a neopentyl group, etc. b is an integer of not less than 2, c is an integer of not less than 1. Preferably, each of E² and E³ is independently a methyl group or an isobutyl group, b is from 2 to 40 and c is from 1 to 40. Methylaluminoxane, methylisobutylaluminoxane and butylaluminoxane are particularly preferable.

The above aluminoxane is prepared by various methods. The method is not specifically limited, and the aluminoxane may be prepared according to a known method. For example, the aluminoxane is prepared by contacting a solution obtained by dissolving a trialkylaluminum (e.g. trimethylaluminum) in a suitable organic solvent (e.g. benzene, aliphatic hydrocarbon) with water. Also, there can be illustrated a method for preparing the aluminoxane by contacting a trialkylaluminum (e.g. trimethylaluminum, etc.) with a metal salt containing crystal water (e.g. copper sulfate hydrate, etc.). It is supposed that thus obtained aluminoxane or a commercial aluminoxane is generally a mixture of (B2) and (B3).

(C) Modified Aluminumoxy Compound

The modified aluminum oxy compound (C) used in the present invention is a modified aluminumoxy compound obtained by reacting an aluminumoxy compound(C1) with a boron compound (C2) represented by the general formula:

BQ¹Q²Q³

wherein B represents a boron atom in the trivalent valence state; Q¹ to Q³ are respectively a halogen atom, a hydrocarbon group, a halogenated hydrocarbon group, a substituted silyl group, an alkoxy group or a di-substituted amino group and they may be the same or different.

(C1) Aluminumoxy compound

An aluminumoxy compound (C1) is used for preparing the modified aluminumoxy compound (C).

Examples of the aluminumoxy compound include methylaluminoxane, ethylaluminoxane, propylaluminoxane, n-butylaluminoxane, isobutylaluminoxane, methylethylaluminoxane, methylbutylaluminoxane, methylisobutylaluminoxane, n-pentylaluminixane, n-hexylaluminoxane and the like.

Further, the aluminumoxy compound (C1) preferably include a cyclic aluminoxanes (C1a) having a structure represented by the general formula {—Al(E²)—O—}_{b},

a linear aluminoxane (C1b) having a structure represented by the general formula E³{—Al(E³)—O—}_{c}AlE³₂

(wherein E²and E³respectively represent a hydrocarbon group, all of E² and all of E³ maybe the same or different, b represents an integer of not less than 2, and c represents an integer of not less than 1.), and a mixture thereof.

The (C1a) and (C1b) are the same as (B2) and (B3) described above, respectively. As the aluminumoxy compound (C1) used in the present invention, isobutylaluminoxane is most preferable.

The aluminumoxy compounds may be used alone or in combination of 2 or more kinds.

(C2) Boron Compound

A boron compound (C2) represented by the general formula:

BQ¹Q²Q³

wherein B and Q¹ to Q³ are the same as defined above, is used in preparation of the modified aluminumoxy compound. Each of Q¹ to Q³ is preferably a halogen atom, a hydrocarbon group having 1 to 20 carbon atoms, a halogenated hydrocarbon group having 1 to 20 carbon atoms, a substituted silyl group having 1 to 20 carbon atoms, an alkoxy group having 1 to 20 carbon atoms or a di-substituted amino group having 2 to 20 carbon atoms, and each of more preferable Q¹ to Q³ is a halogen atom, a hydrocarbon group having 1 to 20 carbon atoms or a halogenated hydrocarbon group having 1 to 20 carbon atoms. Each of the more preferable Q¹ to Q³ is a fluorinated hydrocarbon group having 1 to 20 carbon atoms which contains at least one fluorine atom, and in particular, each of Q¹ to Q³is preferably a fluorinated aryl group having 6 to 20 carbon atoms which contains at least one fluorine atom.

Specific examples of the compound (C2) include tris(pentafluorophenyl)borane, tris(2,3,5,6-tetrafluorophenyl)borane, tris(2,3,4,5-tetrafluorophenyl)borane, tris(3,4, 5-trifluorophenyl)borane, tris(2,3,4-trifluorophenyl)borane, phenylbis(pentafluorophenyl)borane and the like, and tris(pentafluorophenyl)borane is most preferable.

### Production of Modified Aluminumoxy Compound

The modified aluminumoxy compound (C) used in the present invention is obtained by reacting the aluminumoxy compound (C1) with the boron compound represented by the general formula BQ¹Q²Q³ (C2).

The reaction is preferably carried out under an inert gas atmosphere. The reaction temperature is not specifically limited, and is usually −80° C. to 200° C., preferably −50° C. to 150° C., and more preferably 50° C. to 150° C. The reaction time is not specifically limited, and is usually 1 minute to 20 hours and preferably 2 minutes to 15 hours. Further, the reaction may be carried out in the presence or absence of a solvent. The solvent used is not specifically limited, and includes an aliphatic hydrocarbon solvent or an aromatic hydrocarbon solvent. Specific examples thereof include hexane, heptane, benzene, toluene and the like.

The molar ratio of respective components used in the reaction is not specifically limited, and the molar ratio of the component (C1) to the component (C2) [(C1):(C2)] is preferably within a range of 1:3 to 1:0.01, more preferably 1:1 to 1.005.

The modified aluminumoxy compound obtained by the reaction described above can be used as a catalyst component for olefin polymerization after purification by isolation such as recrystallization or the like, but the reaction solution can be also used for the catalyst component for olefin polymerization as it is. [Polymerization of Olefin]

The polymerization catalyst obtained by contacting the above-mentioned (A) and (C), or (A), (B) and (C) is used. As contact methods, any means can be adopted so far as contact of (A) and (B) or (A), (B) and (C) is completed to form the catalyst. For example, a method in which (A) and (B) or further (C) are mixed to contact them together after diluting at least one of them or without diluting them, and a method in which they are separately supplied in a polymerization reactor to contact them together in the reactor, and the like can be adopted.

As a method for supplying respective catalyst components to a polymerization reactor, they are preferably supplied under a water-free condition in an inert gas such as nitrogen, argon or the like.

When (A), (B) and (C) are used to form the catalyst, a reaction product obtained by previously contacting arbitrary two components of them and the remainder may be separately supplied to a polymerization reactor.

With respect to amounts of the respective components used, it is usually desirable to use the respective components so that the molar ratio of the aluminum compound(B) to the transition metal compound (A)[transition metal atom contained in the transition metal compound] is 0.1 to 10000 and preferably 5 to 2000, the molar ratio of the modified aluminumoxy compound(C) to the transition metal compound (A) [transition metal atom contained in the transition metal compound] is 1 to 10000 and preferably 1 to 5000.

When the respective components are used as a solution, a suspension or slurry in which they are dissolved, suspended or slurried in a solvent, the concentration of the respective components is appropriately selected according to the conditions such as the abilities of apparatuses for supplying the respective components in a polymerization reactor, etc. It is desirable to use the respective components so that the concentration of (A) is usually 0.001 to 200 mmol/L in terms of a transition metal atom contained in the transition metal compound (A), more preferably 0.001 to 100 mmol/L and further preferably 0.05 to 50 mmol/L; that of respective (B) and (C) is usually 0.01 to 5000 mmol/L, more preferably 0.1 to 2500 mmol/L and further preferably 0.1 to 2000 mmol/L in terms of Al atom. The method for supplying the respective components or the catalyst in a polymerization reactor is not particularly limited, and the respective catalyst components may be supplied to the polymerization reactor in a solid state, in a state of a solution dissolved with a hydrocarbon solvent, in a suspension state or in a slurry state, or the like.

As olefins which can be applied to the polymerization in the present invention, olefins having 2 to 20 carbon atoms such as, particularly, ethylene and an α-olefin having 3 to 20 carbon atoms, diolefins having 4 to 20 carbon atoms and the like can be used, and two or more of olefins described above as monomers can also be used, simultaneously. Specific examples of the olefin include straight chain olefins such as ethylene, propylene, 1-butene, 1-pentene, 1-hexene, 1-heptene, 1-octene, 1-nonene, 1-decene and the like; branched olefins such as 3-methyl-1-butene, 3-methyl-1-pentene, 4-methyl-1-pentene, 5-methyl-1-hexene and the like; vinylcyclohexane, etc., but the present invention should not be limited to the above-mentioned compounds. Specific examples of the combination of monomers in case of conducting copolymerization include combinations of ethylene with an α-olefin having 3 to 20 carbon atoms such as ethylene with propylene, ethylene with 1-butene, ethylene with 1-hexene, ethylene with 1-octene, a combination of propylene with 1-butene and the like, but the present invention should not be limited thereto.

The present invention can be effectively applied to the production of the copolymer of ethylene and the α-olefin such as in particular, propylene, 1-butene, 4-methyl-1-pentene, 1-hexene, 1-octene or the like.

The polymerization process should not be also specifically limited, and there can be a solvent polymerization or slurry polymerization in which an aliphatic hydrocarbon such as butane, pentane, hexane, heptane, octane or the like; an aromatic hydrocarbon such as benzene, toluene or the like; or a halogenated hydrocarbon such as methylene dichloride or the like is used as a polymerization medium. Further, a high pressure ionic polymerization in which the polymerization of an olefin is conducted without a solvent under which a produced olefin polymer is melt in the olefin in a supercritical liquid state at a high temperature under a high pressure, and a gas phase polymerization in a gaseous monomer and the like are possible. Further, both of a continuous polymerization and a batch-wise polymerization are possible.

The polymerization temperature can be usually adopted within a range of −50° C. to 350° C., preferably 0° C. to 300° C., more preferably 50° C. to 300° C. The present invention is preferably applied to a high temperature polymerization having a highly industrial value. The polymerization temperature is particularly preferably within a range of 150° C. to 350° C.

The polymerization pressure can be adopted at a range of usually normal pressure to 350 Mpa, normal pressure to 300 Mpa, and more preferably normal pressure to 200 Mpa.

In the present invention, the polymerization is preferably performed by a high pressure ionic polymerization. Specifically, the polymerization is carried out at a temperature of 100° C. or more, preferably 135 to 300° C., under a pressure of at least 30 MPa, preferably 35 to 300 MPa.

The polymerization may be performed in a batch-wise manner or a continuous manner, preferably a continuous manner. As a reactor, a stirring vessel type reactor or a tubular reactor can be used. The polymerization can be performed in a single reaction zone. Alternatively, the polymerization can also be performed by partitioning one reactor into a plurality of reaction zones or communicating a plurality of reactors in series or parallel. In case of using a plurality of reactors, a combination of vessel reactors or a combination of a vessel reactor and a tubular reactor may be adopted. In a method for polymerizing using a plurality of reaction zones or a plurality of reactors, polymers having different characteristics can also be produced by changing the temperature, pressure and gas composition of each reaction zone.

In general, the polymerization time is appropriately determined according to the kind of a desired polymer and a reaction apparatus, and the conditions are not specifically limited and a range of 1 minute to 20 hours can be adopted. Further, a chain transfer agent such as hydrogen or the like can also be added to adjust the molecular weight of a copolymer in the present invention.

### EXAMPLE

The present invention is further illustrated in detail according to Examples and Comparative Examples below, but the present invention is not limited thereto.

Properties of the polymers in Examples were measured according to methods described below.

(1) Melting Point of Copolymer

It was measured under the following conditions using SSC5000 thermal analysis system manufactured by Seiko Instruments Inc.

Heating: heating to 150° C. and maintaining for 5 minutes

Cooling: 150° C. to 10° C. (5° C./min.) and maintaining for 10 minutes

Measurement: 10° C. to 160° C. (5° C./min.)

(2) Content of Repeating Unit Derived from α-olefin in Copolymer

It was determined from the characteristic absorption of ethylene and α-olefin using an infrared spectrometer (FTIR1600 series, manufactured by Perkin-Elmer Inc.) and was represented as a short-chain branch (SCB) number per 1000 carbon atoms.

(3) Intrinsic viscosity ([η])

100 mg of a obtained copolymer was dissolved in 50 ml of tetralin at 135° C. and the solution was set in an oil bath maintained at 135° C. Using an Ubbelohde viscometer, the intrinsic viscosity was determined by the falling speed of the tetralin solution in which said sample was dissolved. (Unit: dl/g)

(4) Weight average molecular weight (Mw), number average molecular weight (Mn) and molecular weight distribution (Mw/Mn):

They were determined under the following conditions using gel permeation chromatograph (150° C., manufactured by Waters Co.).

Column: TSK gel GMH-HT

Measurement temperature: set at 145° C.

Measurement concentration: 10 mg/10 ml ortho-dichlorobenzene

### Reference Example 1

[Synthesis of transition metal compound: dimethylsilylene(η⁵-tetramethylcyclopentadienyl) (3-tert-butyl-5-methyl-2-phenoxy)titanium dimethoxide](Compound al)

In a Schlenk tube, 0.131 g (4.1 mmol) of methyl alcohol was dissolved in 10 ml of anhydrous diethyl ether and a diethyl ether solution (3.9 ml, 4.1 mmol) of methyllithium having a concentration of 1.05 mol/L was added dropwise at −78° C. thereto. The resulting mixture was heated to 20° C., the formation of lithium methoxide was confirmed by gas generation, and the resulting reaction solution was again cooled to −78° C. Into the reaction solution, 20 ml of an anhydrous diethyl ether suspension liquid of 0.919 g (2.0 mmol) of dimethylsilylene(η⁵-tetramethylcyclopentadienyl)(3-tert-butyl-5-methyl -2-phenoxy)titanium dichloride which was previously prepared in another Schlenk tube was transferred, and then, the resulting reaction mixture was gradually heated to room temperature to obtain a reaction solution. After concentrating the reaction solution, 20 ml of toluene was added and an insoluble product was separated by filtration. The filtrate was concentrated to obtain dimethylsilylene(η⁵ tetramethylcyclopentadienyl) (3-tert-butyl-5-methyl-2-phenoxy)titanium dimethoxide represented by the structural formula described below of yellow crystals (0.86 g, 95%)(hereinafter, referred to as “Compound al”).

¹H-NMR (270 MHz, C₆D₆); δ7.26 (m, 2H), 4.13(s, 6H), 2.33 (s, 3H), 1.97(s, 6H), 1.89(s, 6H), 1.59(s, 9H), 0.55(s, 6H)

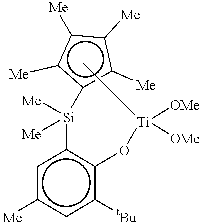

### Example 1(1)

After a dropping funnel was installed on a 50 ml three-necked flask and the atmosphere was replaced with nitrogen, a thermometer was installed. Into the flask, 10 ml of polybutylaluminoxane (PBAO manufactured by Tosoh-Akzo Co., Ltd., hexane solution: 0.68 mol/l) was charged and stirred. Into the dropping funnel, 7.4 ml of trispentafluorophenylborane (toluene solution: 0.19 mol/l) was charged and added dropwise thereto at 25 to 30° C. After completion of the dropwise addition, the resultant was heated and stirred at 60° C. for 4 hours and further at 80° C. for 2 hours. 10.2 ml of toluene was added thereto to obtain a light yellow transparent solution (the concentration of Al is 0.25 mol/l according to the charge amount)(hereinafter, referred to as “Compound c1 solution”).

### Example 1(2)

After the atmosphere of a 0.4 liter inner volume of autoclave type reactor equipped with a stirrer was replaced with argon, 185 ml of cyclohexane as a solvent and 15 ml of 1-hexene as an α-olefin were charged thereto, and the temperature of the reactor was raised to 180° C. After raising the temperature, ethylene was fed while adjusting its pressure at 2.5 Mpa. After the system was stabilized, 2 ml of the Compound c1 solution (equivalent to 0.5 mmol in terms of Al atom) and 0.5 ml of a heptane solution in which a mixture of the compound al and triisobutylaluminum was dissolved(the concentration of the compound a1 is 1 μmol/ml, the concentration of triisobutylaluminum is 50 μmol/ml, and the molar ratio of Al to Ti was adjusted to 50) (namely, 0.5 μmol of the compound a1 and 25 μmol of triisobutylaluminum) were charged. Polymerization was carried out for 2 minutes. As a result of the polymerization, 2.32 g of an ethylene-1-hexene copolymer having a [η] of 1.69 dl/g, an SCB of 29.9, melting points of 85.8° C., Mw of 116600 and Mw/Mn of 1.7 was obtained. Polymerization activity based on 1 mole of Ti atom was 4.6×10⁶ g/mol-Ti per 2 minutes.

### Example 2(1)

After a dropping funnel was installed on a 50 ml three-necked flask and the atmosphere was replaced with nitrogen, a thermometer was installed. Into the flask, 10 ml of polyisobutylaluminoxane (PBAO manufactured by Tosoh-Akzo Co., Ltd., hexane solution: 0.96 mol/l) was charged and stirred. Into the dropping funnel, 9.4 ml of trispentafluorophenylborane (toluene solution: 0.20 mol/l) was charged and added dropwise thereto at 25 to 30° C. After completion of the dropwise addition, the resultant was heated to 95° C. and stirred for 8 hours. A light yellow transparent solution (the concentration of Al is 0.49 mol/l according to the charge amount) (hereinafter, referred to as “Compound c2 solution”) was obtained.

### Example 2(2)

After the atmosphere of a 0.4 liter inner volume of autoclave type reactor equipped with a stirrer was replaced with argon, 185 ml of cyclohexane as a solvent and 15 ml of 1-hexene as an α-olefin were charged thereto, and the temperature of the reactor was raised to 180° C. After raising the temperature, ethylene was fed while adjusting its pressure at 2.5 Mpa. After the system was stabilized, 1.04 ml of the Compound c2 solution(equivalent to 0.5 mmol in terms of Al atom) and 0.5 ml of a heptane solution in which a mixture of the compound al and triisobutylaluminum was dissolved(the concentration of the compound al is 1 μmol/ml, the concentration of triisobutylaluminum is 50 μmol/ml, and the molar ratio of Al to Ti was adjusted to 50) (namely, 0.5 μmol of the compound a1 and 25 μmol of triisobutylaluminum) were charged. Polymerization was carried out for 2 minutes. As a result of the polymerization, 4.15 g of an ethylene-1-hexene copolymer having a [η] of 1.47 dl/g, an SCB of 29.3, melting points of 77.4° C. and 88.3° C., Mw of 100100 and Mw/Mn of 1.9 was obtained. Polymerization activity based on 1 mole of Ti atom was 8.3×10⁶ g/mol-Ti per 2 minutes.

### Comparative Example 1

After the atmosphere of a 0.4 liter inner volume of autoclave type reactor equipped with a stirrer was replaced with argon, 185 ml of cyclohexane as a solvent and 15 ml of 1-hexene as an α-olefin were charged thereto, and the temperature of the reactor was raised to 180° C. After raising the temperature, ethylene was fed while adjusting its pressure at 2.5 Mpa. After the system was stabilized, 0.2 mmol of triisobutylaluminum and 0.5 ml of a heptane solution in which a mixture of the compound al and triisobutylaluminum was dissolved(the concentration of the compound a1 is 1 μmol/ml, the concentration of triisobutylaluminum is 50 μmol/ml) (namely, 0.5 mol of the compound a1 and 25 μmol of triisobutylaluminum) were charged, and subsequently 1.5 ml of a heptane slurry of dimethylaniliniumtetrakispentafluorophenyl borate (slurry concentration of 1 μmol/ml) was charged. Polymerization was carried out for 2 minutes. As a result of the polymerization, 2.33 g of an ethylene-1-hexene copolymer having a [η] of 1.04 dl/g, an SCB of 31.7, melting points of 78.3° C. and 89.9° C., Mw of56500 and Mw/Mn of 1.9 was obtained. Polymerization activity based on 1 mole of Ti atom was 4.7×10⁶ g/mol-Ti per 2 minutes.

### Comparative Example 2

After the atmosphere of a 0.4 liter inner volume of autoclave type reactor equipped with a stirrer was replaced with argon, 185 ml of cyclohexane as a solvent and 15 ml of 1-hexene as an α-olefin were charged thereto, and the temperature of the reactor was raised to 180° C. After raising the temperature, ethylene was fed while adjusting its pressure at 2.5 Mpa. After the system was stabilized, 0.72 ml (equivalent to 0.5 mmol in terms of Al atom) of polybutylaluminoxane (PBAO manufactured by Tosoh-Akzo Co., Ltd., and hexane solution: 0.68 mol/l), 0.5 ml of a heptane solution in which the compound al and tributylaluminixane were mixed (the concentration of the compound al was 1 μmol/ml and the concentration of PBAO was 50 μmol/ml, the molar ratio of Al atom to Ti atom was adjusted at 50.) (namely 0.5 μmol of the compound al and 25 μmol of tributylaluminixane), and 1.5 ml of a heptane slurry of N,N-dimethylaniliniumtetrakispentafluorphenylborate (concentration of 1 μmol/ml) were charged. Polymerization was carried out for 2 minutes. As a result of the polymerization, 2.20 g of an ethylene-hexene-1 copolymer having an [η] of 0.98 dl/g, a SCB of 34.8, melting points of 73.6° C. and 84.9° C., a Mw of 56300 and a Mw/Mn of 2.4 was obtained. Polymerization activity based on 1 mole of Ti atom was 4.4×10⁶ g/mol-Ti per 2 minutes. Comparative Example 3

After the atmosphere of a 0.4 liter inner volume of autoclave type reactor equipped with a stirrer was replaced with argon, 140 ml of cyclohexane as a solvent and 60 ml of 1-hexene as an α-olefin were charged thereto, and the temperature of the reactor was raised to 180° C. After raising the temperature, ethylene was fed while adjusting its pressure at 2.5 Mpa. After the system was stabilized, 1.04 ml of the Compound c2 solution(equivalent to 0.5 mmol in terms of Al atom) prepared in Example 2(1) and 0.5 ml of a heptane solution in which a mixture of bis-n-butylcyclopentadienylzirconium dichloride(herein-after, referred to as “compound a2”) and triisobutylaluminum was dissolved (the concentration of the compound a2 is 1 μmol/ml, the concentration of triisobutylaluminum is 50 μmol/ml, and the molar ratio of Alto Zr was adjusted to 50) (namely, 0.5 μmol of the compound a2 and 25 μmol of triisobutylaluminum) were charged. Polymerization was carried out for 2 minutes. As a result of the polymerization, 1.37 g of an ethylene-1-hexene copolymer having a [η-9 of 0.49 dl/g, an SCB of 9.3, melting points of 111.2° C. and 115.5° C., Mw of 20700 and Mw/Mn of 2.01 was obtained. Polymerization activity based on 1 mole of Zr atom was 2.7×10⁶ g/mol-Zr per 2 minutes.

As described above in detail, according to the present invention, an olefin polymerization catalyst giving an olefin polymer of high molecular weight and a process for producing an olefin polymer of high molecular weight are provided.

What is claimed is:

1. An olefin polymerization catalyst prepared by a process comprising contacting (A) and (B), or (A), (B) and (C) described below:
(A) a transition metal compound in which the number of a transition metal is the same as that of group having a cyclopentadiene type anion skeleton, in its molecule,
(B) at least one aluminum compound selected from the following (B1) to (B3);
(B1) an organoaluminum compound represented by the general formula E¹ₐAlZ₃₋ₐ,
(B2) acyclic aluminoxane having a structure represented by the general formula {—Al(E²)—O—}_{b}, and
(B3) a linear aluminoxane having a structure represented by the general formula E³{—Al(E³)—O—}_{c}AlE³₂,
wherein E¹, E² and E³ respectively represent a hydrocarbon group, all of E¹, E² and E³ may be the same or different, Z represents a hydrogen atom or a halogen atom, and all of Z may be the same or different, a represents a numeral satisfying 0<a≦3, b represents an integer of not less than 2, and c represents an integer of not less than 1; and
(C) a modified aluminumoxy compound obtained by reacting an aluminumoxy compound (C1) with a boron compound (C2) represented by the general formula BQ¹Q²Q³,
wherein B is a boron atom in the trivalent valence state; and Q¹, Q² and Q³ are respectively a halogen atom, a hydrocarbon group, a halogenated hydrocarbon group, a substituted silyl group, an alkoxy group or a di-substituted amino group, and they may be the same or different.

2. The olefin polymerization catalyst according to claim 1, wherein (C1) is (C1a) and/or (C1b) described below:
(C1a) a cyclic aluminoxane having a structure represented by the general formula {—Al(E²)—O—}_{b}, and
(C1b) a linear aluminoxane having a structure represented by the general formula E³{—Al(E³)—O—}_{c}AlE³₂,
wherein E² and E³ respectively represent a hydrocarbon group, all of E² and all of E³ may be the same or different, b represents an integer of not less than 2, and c represents an integer of not less than 1.

3. The olefin polymerization catalyst according to claim 1, wherein respective Q¹, Q² and Q³ are a halogenated hydrocarbon group.

4. The olefin polymerization catalyst according to claim 1, wherein the modified aluminumoxy compound(C) is obtained by reacting the aluminumoxy compound (C1) with the boron compound (C2) at a temperature of from 50° C. to 150° C.

5. The olefin polymerization catalyst according to claim 1, wherein the transition metal compound (A) is a transition metal compound represented by the general formula (I) or (II):
CpMX¹₃ (I)
(CPMX¹ₘ)₂X²₃₋ₘ (II),
wherein M represents a transition metal atom of the Group IV of the Periodic Table of the Elements; Cp represents a group having a cyclopentadiene type anion skeleton; each of X¹'s independently represents a hydrogen atom, a halogen atom, an alkyl group, an aralkyl group, an aryl group, a substituted silyl group, an alkoxy group, an aralkyloxy group, an aryloxy group, a di-substituted amino group, an alkylthio group, an aralkylthio group, an arylthio group, an alkylseleno group, an aralkylseleno group or arylseleno group; X² represents an atom of Group XVI of the Periodic Table of the Elements; m is 1 or 2; when a plurarity of respective Cp, M, X¹ and X² exists, they may be respectively the same or different, and Cp may be bonded to X¹ directly or through a bridging group.

6. The olefin polymerization catalyst according to claim 5, wherein (A) is a transition compound in which Cp and X¹ in the general formula (I) or (II) are bonded each other through a bridging group.

7. The olefin polymerization catalyst according to claim 1, wherein (A) is a transition metal compound represented by the general formula (III) or (IV) below:
CpYMX¹₂ (III)
(CpYMX¹ₙ)₂X²₂₋ₙ (IV),
wherein respective M, Cp, X¹ and X² is the same as defined in the general formula (I)or (II) above; Y is a group having an atom of the Group XV or XVI of the Periodic Table of the Elements and σ-bonding to M through the atom in the group; Cp and X¹ may be bonded each other directly or through a bridging group; n is 0 or 1; and a plurarity of respective Cp, M, X¹ and X² may be the same or different.

8. The olefin polymerization catalyst according to claim 1, wherein (A) is a transition metal compound selected from the group consisting of transition compounds represented by the general formulas (I), (II) or (III); 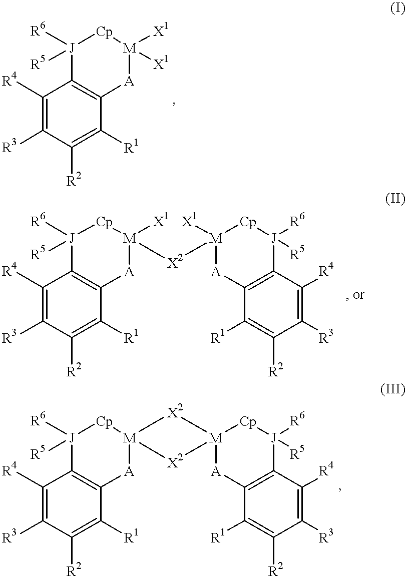
wherein, in the general formula (I), (II] or (III], M represents a transition metal atom of the Group IV of the Periodic Table of the Elements; A represents an atom of the Group XVI of the Periodic Table of the Elements; J represents an atom of the Group XIV of the Periodic Table of the Elements; Cp represents a group having a cyclopentadiene type anion skeleton; each of X¹, R¹, R², R³, R⁴, R⁵ and R⁶ independently represents a hydrogen atom, a halogen atom, an alkyl group, an aralkyl group, an aryl group, a substituted silyl group, an alkoxy group, an aralkyloxy group, an aryloxy group, a di-substituted amino group, an alkylthio group, an aralkylthio group, an arylthio group, an alkylseleno group, an aralkylseleno group or arylseleno group; X² represents an atom of Group XVI of the Periodic Table of the Elements; R¹, R², R³, R⁴, R⁵ and R⁶ may be optionally combined with each other to form a ring; and in the general formula (II) or (III), two of M, A, J, Cp, X¹, X², X³, R¹, R², R³, R⁴, R⁵ and R⁶ may be respectively the same or different.

9. The olefin polymerization catalyst according to claim 1, wherein (B) is an organoaluminum compound selected from the group consisting of triethylaluminum, triisobutylaluminum, methylaluminoxane, methylisobutylaluminoxane and butylaluminoxane.

10. A process for producing an olefin polymer which comprises polymerizing an olefin with the olefin polymerization catalyst of any one of claims 1 to 9.

11. The process for producing an olefin polymer according to claim 10, wherein the olefin polymer is a copolymer of ethylene and an α-olefin having 3 to 20 carbon atoms.

12. The process for producing an olefin polymer according to claim 10, the polymerization temperature is 150 to 300° C.

13. The process for producing an olefin polymer according to claim 11, the polymerization temperature is 150 to 300° C.
